(19) United States
(12) Patent Application Publication
(10) Pub. No.: US 2004/0199877 A1
(43) Pub. Date: Oct. 7, 2004

(54) System for processing handwritten document and method for processing handwritten document

(76) Inventors: Hiroshi Yasuda, Kanagawa (JP); Tomohiko Beppu, Kanagawa (JP)

Correspondence Address: MORRISON & FOERSTER LLP, 1650 TYSONS BOULEVARD, SUITE 300, MCLEAN, VA, 22102, US

(21) Appl. No.: 10/799,607

(22) Filed: Mar. 15, 2004

(30) Foreign Application Priority Data
Mar. 17, 2003 (JP) 2003-072627
Mar. 17, 2003 (JP) 2003-072628

(51) Int. Cl. G06K 9/00

(52) U.S. Cl. 715/541

(57) ABSTRACT

A system for processing a handwritten document, including a receiving terminal configured to acquire handwritten information that is handwritten on a document. The receiving terminal includes a format acquisition part which acquires the format of the document from the format storage terminal, a printing part which prints the document based on the format acquired by the format acquisition part, a handwritten information acquiring part which acquires the handwritten information that is handwritten on the document, and a handwritten information transmitting part which transmits the handwritten information to the document receiving terminal.

### BACKGROUND OF THE INVENTION

1. Field of the Invention

The present invention relates to systems for processing a handwritten document and methods for processing a handwritten document.

2. Description of the Related Art

Because of widespread use of a personal computers and the Internet, it may be possible to perform various applications via the Internet without using paper. Hence, for example, construction of an electronic local government is promoted in the field of local governments.

At present, various applications for work by a public office provided for residents are submitted by paper applications. On the other hand, public offices have started constructing the electronic local government for the applications for work wherein applications may be received anytime and anywhere 24 hours a day and 365 days a year, so that service for residents can be improved. More specifically, in the electronic local government, the residents can apply via a personal computer or public terminal (information kiosk) and the public office can receive the application as electronic application information.

However, not all the residents can operate the personal computers. Hence, it is expected that the public office will provide for two kinds of application methods, namely the application by conventional handwriting and the electronic application.

Thus, because of handling the conventional handwritten application document and construction of the electronic local government, a staff member of the public office has to perform electronic operations such as inputting the contents of a received handwritten application document by using a keyboard.

Furthermore, is may be impossible to handle the handwritten application document by a terminal other than a terminal of the public office in a case where the staff member or an alternative member is not located in the public office.

In addition, certifications of applicants are necessary for most of the application documents. Furthermore, it is usual to require payment of a service fee for many of the kinds of service of the local government, such as acquisition of a resident's card.

### SUMMARY OF THE INVENTION

Accordingly, it is a general object of the present invention to provide a novel and useful system for processing a handwritten document and a method for processing a handwritten document, in which one or more of the problems described above are eliminated.

Another and more specific object of the present invention is to provide a system for processing a handwritten document, including:

a receiving terminal configured to acquire handwritten information that is handwritten on a document;

a document receiving terminal configured to receive the handwritten information that is transmitted from the receiving terminal; and

a format storage terminal configured to store a format of the document,

wherein the receiving terminal includes:

a format acquisition part which acquires the format of the document from the format storage terminal;

a printing part which prints the document based on the format acquired by the format acquisition part;

a handwritten information acquiring part which acquires the handwritten information that is handwritten on the document; and

a handwritten information transmitting part which transmits the handwritten information to the document receiving terminal.

The system may further include a certifying terminal configured to certify a user who handwrites the handwritten information on the document,

wherein the receiving terminal may further include:

a certifying part which transmits and received necessary information for the certification to and from the certifying terminal;

an accounting process part which collects a service fee required based on printing of a publication document which is published based on an application made by the document; and

a publication document information acquiring part which acquires information regarding the publication document from the document receiving terminal.

The above objects of the present invention are achieved by a method for processing a handwritten document in a system for processing document, the system including a receiving terminal configured to acquire handwritten information that is handwritten on a document; a document receiving terminal configured to receive the handwritten information that is transmitted from the receiving terminal; and a format storage terminal configured to store a format of the document, the method including the steps of:

a) acquiring the format of the document from the format storage terminal;

b) printing the document based on the format acquired;

c) acquiring the handwritten information that is handwritten on the document; and

d) transmitting the handwritten information to the document receiving terminal.

In the method, the system may further include a certifying terminal configured to certify a user who handwrites the handwritten information on the document, and the method may further including the steps of:

e) transmitting and receiving necessary information for the certification to and from the certifying terminal,

f) collecting a service fee required based on printing of a publication document which is published based on an application made by the document; and

g) acquiring information regarding the publication document from the document receiving terminal.

Other objects, features, and advantages of the present invention will become more apparent from the following detailed description when read in conjunction with the accompanying drawings.

### BRIEF DESCRIPTION OF THE DRAWINGS

FIG. 1 is a schematic view showing a system for processing a handwritten document of a first embodiment of the present invention;

FIG. 2 is a block diagram of the hardware structure of a computer system of the first embodiment;

FIG. 3 is a software block diagram of a multi-function machine 11;

FIG. 4 is a schematic diagram showing an application document;

FIG. 5 is a table showing a local government data base of the first embodiment;

FIG. 6 is a sequence diagram showing a process by which the multi-function machine 11 acquires a resident's card;

FIG. 7 is a schematic diagram showing a certificate;

FIG. 8 is a schematic diagram showing a system for processing a handwritten document of a second embodiment of the present invention;

FIG. 9 is a perspective view showing a handwriting input device 120;

FIG. 10 is a software block diagram of a personal computer 110 for receiving;

FIG. 11 is a schematic view showing details of a handwritten information editing part 380;

FIG. 12 is a table showing a local government data base of the second embodiment; and

FIG. 13 is a sequence diagram showing a process by which the personal computer 110 for receiving transmits to a local government terminal 10.

### DETAILED DESCRIPTION OF THE PREFERRED EMBODIMENTS

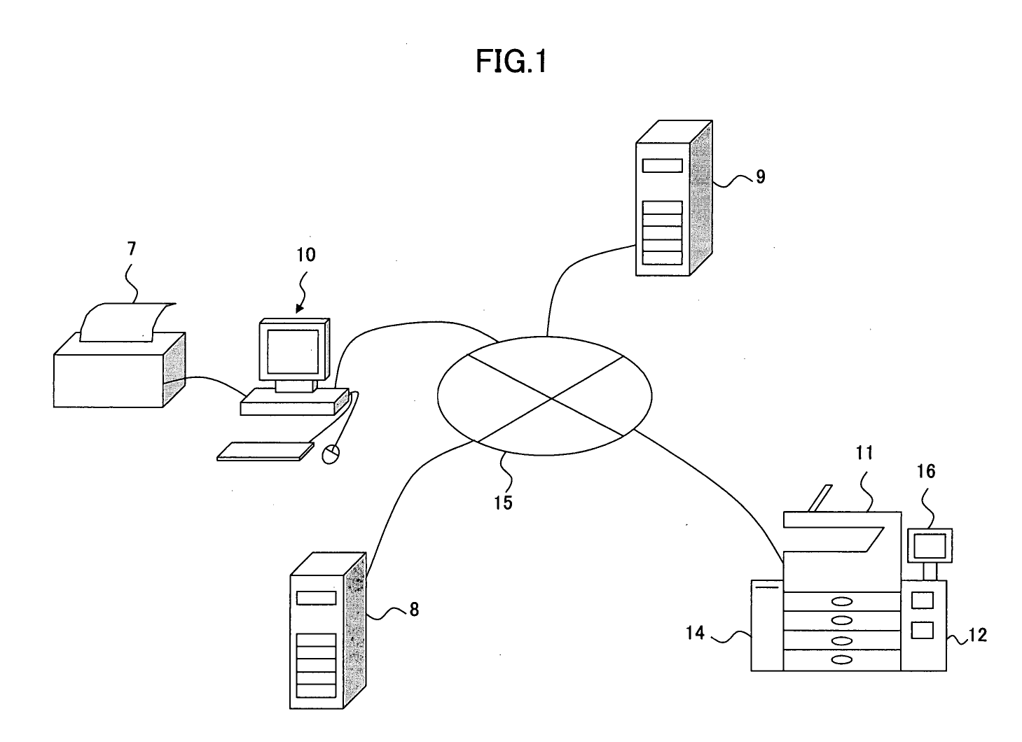

A description of a system for processing a handwritten document and a method for the same, is given below, with reference to the FIGS. 1 through 13 of embodiments of the present invention.

(First Embodiment)

FIG. 1 is a schematic view showing an example of a system for processing a handwritten document of the first embodiment of the present invention. As shown in FIG. 1, a system for a processing handwritten-documents of the first embodiment of the present invention includes a local government server 10, a printer 7, a multi-function machine 11, an IC card installation part 14, an accounting part 12, a DB server 9 which functions as a format storage terminal, a certification server 8 which functions as a certification terminal, and a network 15.

An operations panel 16 is provided at the multi-function machine 11. An applicant touches the operations panel 16 so that information is input. Furthermore, information is displayed on the operation panel 16 for the applicant. The network 15 includes the Internet, a LAN (Local Area Network) and a VPN (Virtual Private Network).

The multi-function machine 11, the IC card installation part 14, the accounting part 12, and the operations panel 16 form a receiving terminal. The local government server 10 or the local government server 10 having a printer functions as a document receiving terminal.

The local government server 10 is a server provided at a public office such as a building of the local government. Although only one local government server 10 is shown in FIG. 1, a plurality of the local government servers 10 may be provided at a plurality of local governments, and, in this case, a plurality of clients (residents) are generally exist for each of the local governments.

The multi-function machine 11 is provided at a station or a convenience store. The multi-function machine 11 may be an exclusive terminal such as a public terminal (information kiosk). An application document or a resident's card, for example, can be output by the multi-function machine 11. Furthermore, the application document which is handwritten by the applicant can be read and the handwritten information transmitted to the local government server 10, by the multi-function machine 11. The multi-function machine 11 may be provided at the public office. Identifier information is provided for respective application documents so that the multi-function machine 11 can identify the purpose of the application document.

An IC card is inserted into the IC card installation part 14 so as to certify the applicant.

A service fee required for the applicant to acquire to the resident's card, for example, is deposited in the accounting part 12 which functions as a functioning process part.

The DB server 9 is a data base server wherein all of a country's standard application formats corresponding to respective local governments are stored. The DB server 9 may be, for example, a server provided at an IDC (Internet Data Center). The IDC may function as an ASP (Application Service Provider). The IDC may provide an application made for by the local government server 10, the multi-function machine 11, and others.

The IDC and the respective local governments are connected by an LGWAN (Local Government Wide Area Network). The multi-function machine 11 is connected to the IDC or the local government by the Internet. The local government server 10 may be provided at the local government office, or provided at the IC for being commonly used by the ASP, for example.

A support center for performing support 24 hours a day, not shown in FIG. 1, may be provided in the system. This is because an operations method in a case where the applicant writes in error should be supported when the multi-function machine 11 is provided at a convenience store, for example.

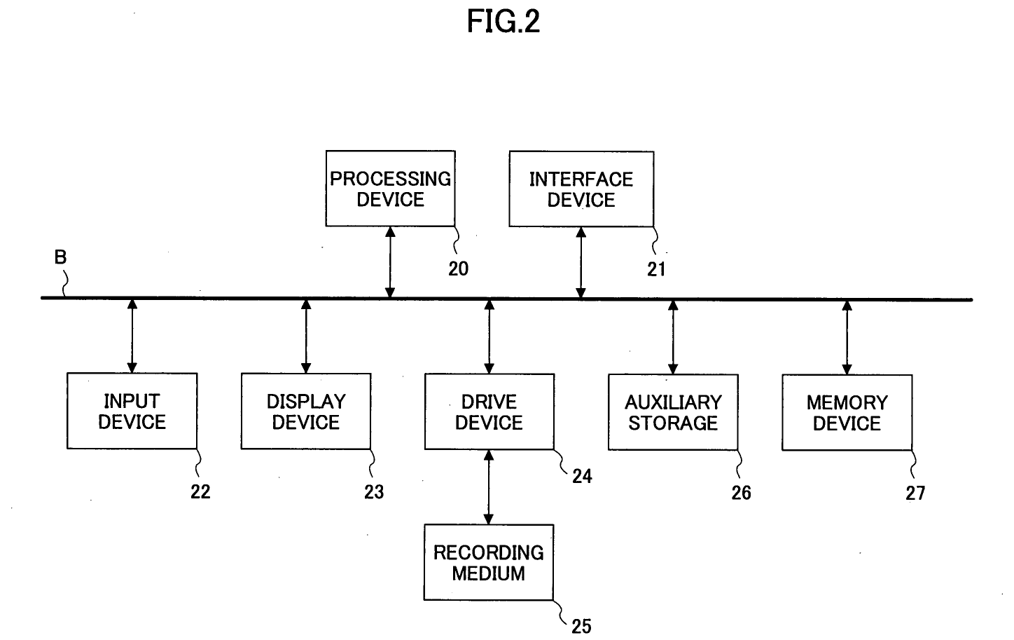

Next, referring to FIG. 2, a hardware structure of a computer system such as the local government server 10, the certification server 8, the DB server 9, or the like shown in FIG. 1 is described.

As shown in FIG. 2, the hardware structure of the computer system includes a processing device 20, an interface device 21, an input device 22, a display device 23, a drive device 24, a recording medium 25, an auxiliary storage 26, and a memory device 27, which are mutually connected by a bus B.

The input device 22 is formed by a keyboard and mouse operated by the applicant. The input device 22 is used for inputting various operation signals to the computer system.

Various windows required for operating the computer system, viewing data, or the like are displayed at the display device 23. The interface device 21 is an interface for connecting the computer system to the network or an interface for connecting other devices. The interface device 21 is, for example, formed by an NIC (Network Interface Card), a modem, or a USB (Universal Serial Bus).

A program for operating the above mentioned computer system is provided by the recording medium 25 such as a CD-ROM or downloaded via the network. The recording medium 25 is loaded in the drive apparatus 24 so that the data or program is installed from the recording medium 25 to the auxiliary storage 26 via the drive device 24.

The data or program, necessary files, and others are stored in the auxiliary storage 26. The program is read from the auxiliary storage 26 at the time of starting the computer system and loaded into the memory device 27. The processing device 20 performs by following the program loaded in the memory device 27.

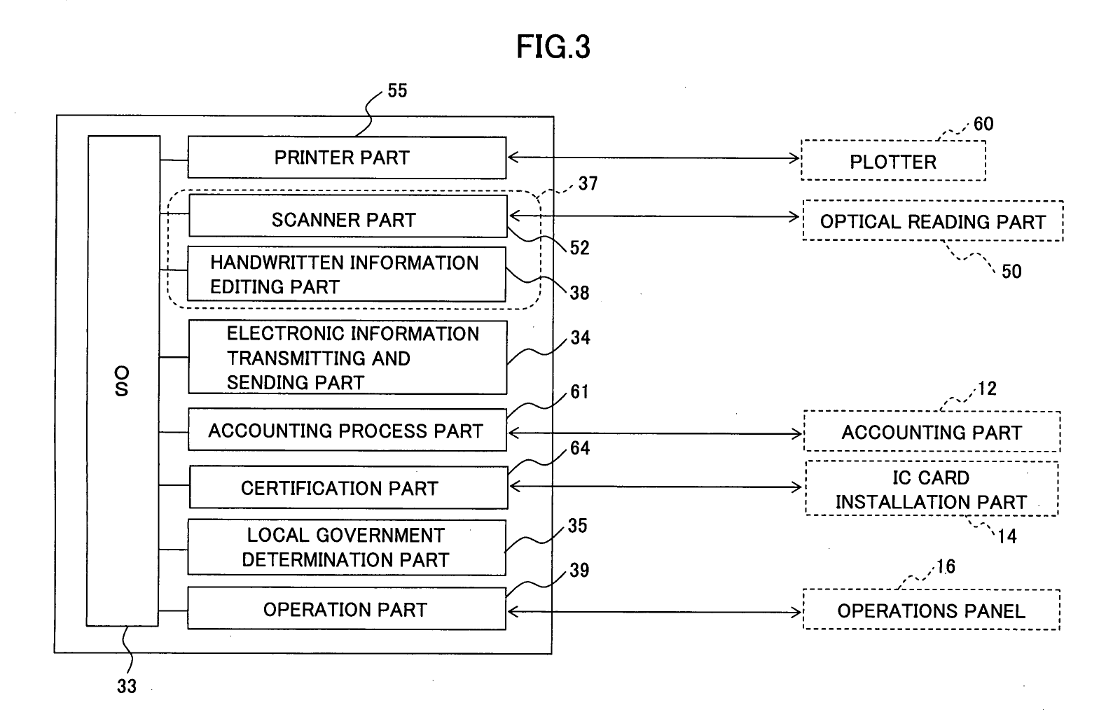

FIG. 3 is a software block diagram of the multi-function machine 11. Referring to FIG. 3, the multi-function machine 11 includes a printer part 55 operated by an OS 33, a scanner part. 52, a handwritten information editing part 38, an electronic information transmitting and receiving part 34, an accounting process part 61, a certification part 64, a local government determination part 35, and an operation part 39. The multi-function machine 11 has a plotter part 60, an optical reading part 50, the accounting part 12, the IC card installation part 14 and the operation panel 16, as hardware on which the above mentioned software works. The scanner part 52 and the handwritten information editing part 38 form a handwritten input part 37.

The printer part 55 functioning as a printing part prints by using the plotter 60. The scanner part 52 reads an image pictured on the application document, for example, by using the optical reading part 50. The handwritten information editing part 38, functioning as a handwritten information acquiring part, edits the handwritten information such as recognizing a letter (character) from the image read by the scanner part 52, or acquiring the position of the letter (character) that is recognized or identifier information that is described below.

The electronic information transmitting and receiving part 34 functions as a format acquiring part, a handwritten information transmitting part, and a publication document information acquiring part. That is, the electronic information transmitting and receiving part 34 receives a format of the application document from the DB server 9, transmits and receives information regarding certification of the applicants by the certification server 8, and transmits handwritten information edited by the handwritten information editing part 38 to the local government server 10.

The payment amount is determined by the accounting process part 61. The accounting process part 61 also controls the accounting part 63 wherein money is actually deposited. The certification part 64 exchanges information with the certification server 8 based on information read from the IC card installed in the IC card installation part 14, and thereby certifies the applicant. The local government determination part 35 determines a local government ID that is described below for a local government selected by the applicant. The operation part 39 controls the operations panel 16.

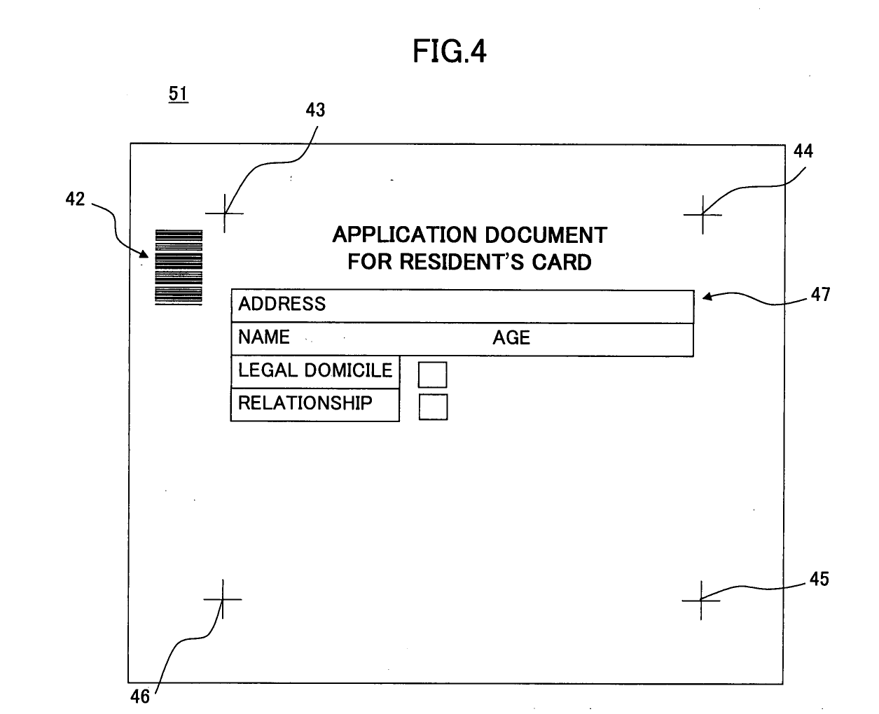

Next, the application document printed by the multi-function machine 11 is described with reference to FIG. 4. FIG. 4 is a schematic diagram showing the application document for the resident's card as an example of the application document 51. When the application document 51 is printed, not only image data 47 indicating entry sections such as address and name but also readable mark image 42 are printed on the application document 51. The mark image 42 functions as identifier information for identifying the application document.

Furthermore, marks 43, 44, 45, and 46 for positioning, so-called dragonflies, are printed at an inner circumference of the application document 51. The actual application document is provided inside of the dragonflies 43, 44, 45, and 46. In order to avoid blocking the image data 47, it is preferable that the mark image 42 be printed outside of the dragonflies 43, 44, 45, and 46.

Thus, it is possible to avoid damaging contents of the original application document by printing the mark image 42 outside of the dragonflies 43, 44, 45, and 46.

Furthermore, the mark image 42 printed on the application document 51 is identifier information for identifying a format of the application document 51. Therefore, it is possible to identify the format of the application document at the time of reading the printed application document 51.

A letter (character) which a human can read may be used as the identifier information, instead of a bar code as shown in FIG. 4.

Furthermore, in a case where the identifier information is a bar code, it is possible to use either a one dimensional bar code or a two dimensional bar code. However, it is preferable to use a two dimensional code in terms of easy reading or the amount of data capable of being recorded by the bar code.

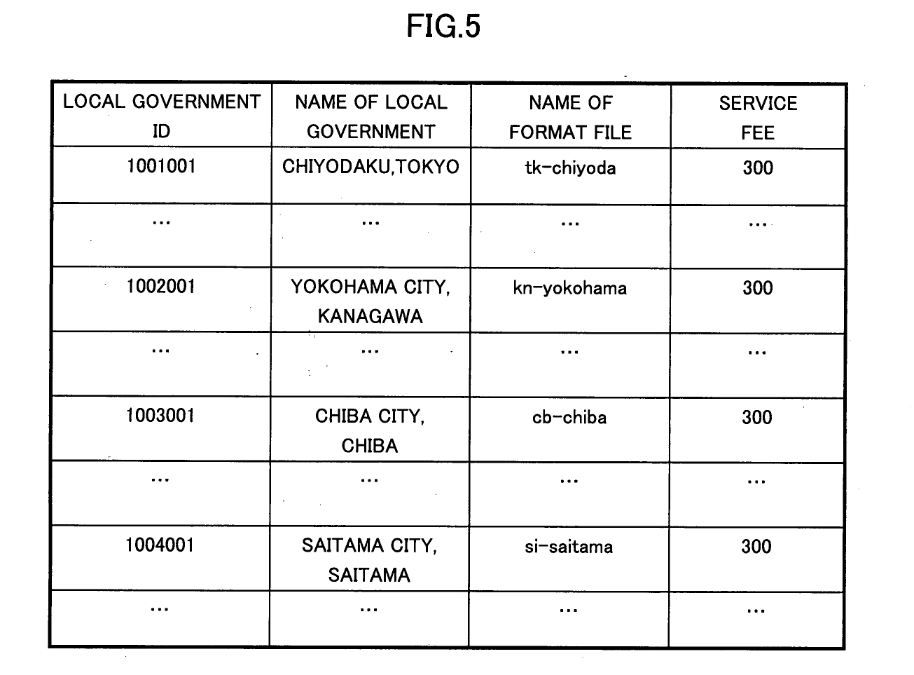

Next, with reference to FIG. 5, a local government data base (hereinafter “DB”) wherein all of a country's standard application formats are stored, which is installed in the DB server 9, is explained with reference to FIG. 5. For convenience of explanation, the local government DB shown in FIG. 5 corresponds to only the resident's card.

The local government DB shown in FIG. 5 is formed by four items, namely a local government ID, a name of the local government, a name of a format file, and a service fee.

The local government ID is a number given to each local government separately. The name of the local government is the name of a local government corresponding to the local government ID. The name of the format file is the name of a file where a format of each local government is stored. The service fee is a fee for collection by the accounting process part of the multi-function machine 11. The service fee is a fee per each resident's card.

For example, in a case where the local government ID is 1001001, the local government is Chiyodaku, Tokyo, the name of the file where a format is stored is tk-chiyoda, and the service fee is 300 yen. Because of this local government DB, if the local government ID is designated by the multi-function machine 11, the DB server 9 searches the local government DB with the local government ID as a key, so that the name of the format file and the service fee are acquired and the DB server 9 transmits the format stored in the format file and amount of the service fee to the multi-function machine 11.

The multi-function machine 11 also has data formed by the local government ID and the name of the local government among items of the local government DB shown in FIG. 5. The multi-function machine 11 searches for the local government ID with names of prefectures and cities selected by the applicant as keys, so as to transmit the selected local government ID to the DB server 9.

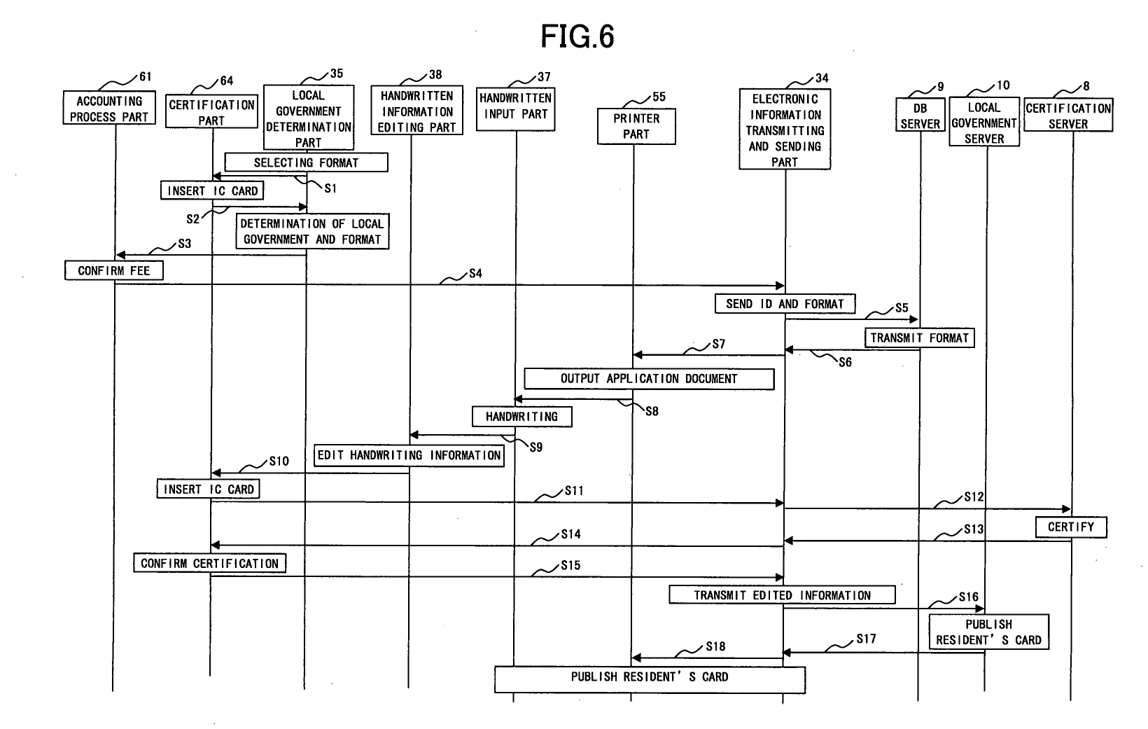

Next, a process wherein the multi-function machine 11 prints the resident's card is explained with reference to a sequence diagram shown in FIG. 6. In FIG. 6, a process by which respective software blocks provided at the multi-function machine 11, the DB server 9, the local government server 10, and the certification server 8 perform work, is shown.

First, the applicants selects the application document format by using the operations panel 16, and the local government determination part 35 gives notice for performing a certification process to the certification part 64 (Step 1).

Next, the certification part 64 reads the address, name, gender, date of birth, age, and others from the IC card inserted into the IC card installation part 19 by the applicant. The certification part 64 gives notice of the local government that is read to the local government determination part 35 (Step 2). Because of this, it is possible for the local government determination part 35 to determine the local government and the application document format.

The local government determination part 35 gives notice of the fee for performing the work to account to the accounting process part 61 (Step 3).

After confirming payment of the printing fee, the accounting process part 61 gives notice for transmitting the local government ID and the application document format to the electronic information sending and transmitting part 34 (Step 4). The electronic information sending and transmitting part 34 transmits the local government ID and the application document format to the DB server 9 (Step 5).

The DB server 9 transmits the application document format (Step 6). The application document format is transmitted from the electronic information sending and transmitting part 34 to the printer part 55 (Step 7). The printer part 55 performs a printing step. That is, the printer part 55 prints information of the applicant read by the certification part 64 to a corresponding section of the application document so that the application document is printed based on the format. At this time, the identifier information is also printed.

Next, the printer part 55 gives the handwritten input part 37 a notice indicating printing is completed (Step 8).

The handwritten input part 37 performs a handwritten information acquiring step. That is, the handwritten input part 37 performs a process for acquiring handwritten information that is handwritten, by the applicant, on the application document that is input on paper, and transmits the handwritten information to the handwritten information editing part 38 (Step 9). The handwritten information editing part 38 edits the handwritten information.

After editing the handwritten information, the handwritten information editing part 38 gives notice for performing a notifying step to the certification part 64 (Step 10). The certification part 64 transmits information read from the IC card which has been inserted, to the certification server 8 via the electronic information transmitting and receiving part 34 (Step 11 and Step 12).

The certification server 8 performs certification processing. A result certified by the certification server 8 is transmitted to the certification part 64 via the electronic information transmitting and receiving part 34 (Step 13 and Step 14). The certification part 64 confirms that the certification server 8 has certified, from the certification result that is received. The above-discussed Steps 11 through 14 correspond to a certification step.

The certification part 64 which confirms the certification gives a notice for transmitting edited and handwritten information to the local government server 10, to the electronic information transmitting and receiving part 34 (Step 15). The electronic information transmitting and receiving part 34 transmits the edited and handwritten information to the local government server 10 (Step 16). At this time, handwritten information on the application document as image data, in addition to letters (characters) handwritten on the application document as letter (character) information, are transmitted.

The local government server 10 publishes a resident's card as a publication document and transmits the resident's card which is published (Step 17). The electronic information transmitting and receiving part 34 that receives the resident's card transmits the resident's card to the printer part 55 (Step 18). The printer part 55 performs a watermark printing process and, at the same time, adds an image seal and printing time, and thereby the resident card's is published.

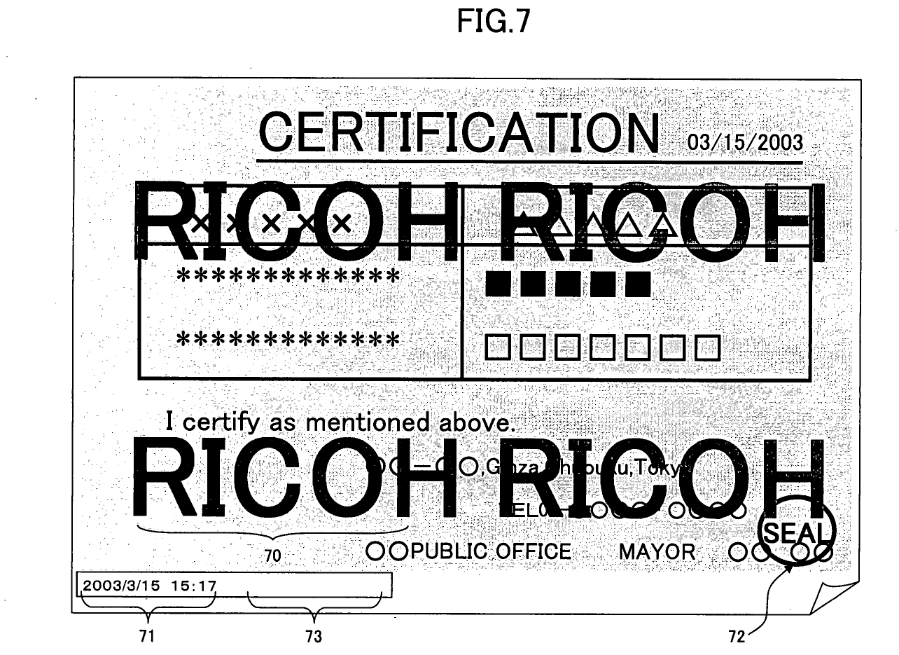

FIG. 7 is a schematic diagram showing a certificate that is published by the above-discussed steps. A printed pattern 70, date and time 71 and 73, and an image seal are provided on the certificate shown in FIG. 7. If an original of certificate is copied, the printed pattern 70 becomes a letter (character) appearing on the copy. In this case, letters (characters) “RICOH” appear. Because of this printed pattern 70, it is clearly shown that the copied paper is not original.

The date and time 71 and 73 represent a date and time when the certificate is published. The same date and time are printed at sections 71 and 73. The time and date 73 does not appear in FIG. 7 because it is disappears when the certificate is copied. Hence, because of the date and time 71 and 73, it is shown that the copied paper is not original. Furthermore, since the forged date and time does not exist in the records of the local government server 10, it is determined that the paper is forged. The image seal 72 is printed as a matter of formality.

In the above discussed processes, if the IC card has a function of a debit card, the accounting process part 61 may perform so as to charge the fee to the debit card. Furthermore, in a case of either cash or the debit card, a receipt is printed.

Also, a settling account server is provided and depositing details may be recorded at the settling account server, and thereby the depositing details may be provided to respective local governments.

In the system and method for processing a handwritten document of the first embodiment, people who cannot obtain the advantage of improved service for residents because they are not good at operating a personal computer, despite of construction of an electronic local government, can electronically apply with a conventional paper handwritten application document.

Furthermore, a staff member of a public office does not have to work on both paper applications and electronic applications. In addition, people who follow do not wait for long time for one person to make an application at a place receiving personal computer is arranged such as a convenience store.

According to the first embodiment of the present invention, it is possible to provide a system and method for processing a handwritten document, and thereby a handwritten document is made electronic and certification of the applicant and collection of the service fee are performed.

(Second Embodiment)

In the second embodiment, parts that are the same as the parts shown in the first embodiment (FIG. 1 through FIG. 7) are given the same reference numerals, and explanation thereof is omitted.

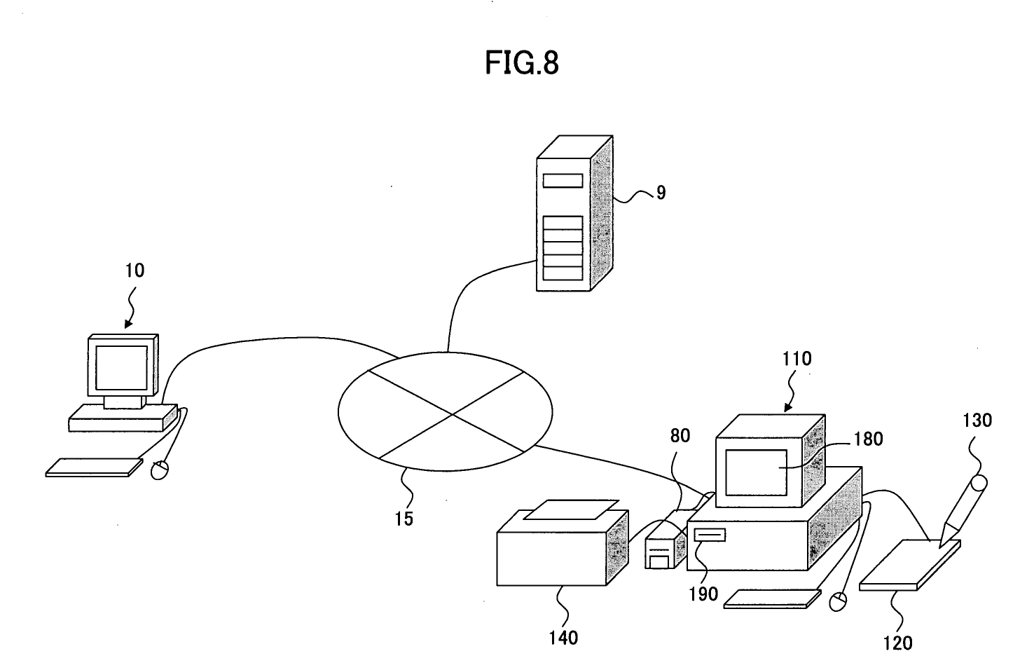

FIG. 8 is a schematic diagram showing an example of a system for processing a handwritten document of the second embodiment of the present invention. As shown in FIG. 8, the system for a processing a handwritten document of the second embodiment of the present invention includes a local government server 10, a receiving personal computer 110, a printer 140, a handwriting input device 120, an exclusive pen 130, a touch panel 180, an IC card installation part 190, an accounting part 80, a DB server 9 which function as a format storage terminal, and a network 15.

The receiving personal computer 110, the printer 140, the handwriting input device 120, the exclusive pen 130, the IC card installation part 190 and the accounting part 80 form a receiving terminal. The touch panel 180 may be installed if necessary.

The receiving personal computer 110 is provided at a station or a convenience store, for example. The receiving personal computer 110 may be an exclusive terminal such as a public terminal (information kiosk). The application document which is a document handwritten by the applicant, can be read and the handwritten information transmitted to the local government server 10, by the receiving personal computer 110. The receiving personal computer 110 may be provided at the public office.

The printer 140 prints the application document on which the applicant writes. Identifier information described below is also printed on the printed application document.

The handwriting input device 120 acquires the handwritten information from the application document which the applicant inputs by handwriting. The applicant handwrites on the application document by using the exclusive pen 130. The device for acquiring the handwritten information may be a scanner instead of the handwriting input device 120 shown in FIG. 1. In a case where the device for acquiring the handwritten information is a scanner, the handwritten information is acquired by the scanner reading the handwritten application document of the applicant. Furthermore, the identifier information is provided on respective application documents so that the handwriting input device 120 can identify the purpose of the application document.

The IC card is inserted into the IC card installation part 190 so as to certify the applicant.

A service fee required for the applicant to acquire the resident's card or a fee for printing the application document, is deposited in the accounting part 80.

The DB server 9 is a data base server wherein all of a country's standard application formats corresponding to respective local governments are stored. The DB server 9 may be, for example, a server provided at an IDC (Internet Data Center). The IDC may function as an ASP (Application Service Provider). The IDC may provide an application for work by the local government server 10, the receiving personal computer 110, and others.

A support center for performing support 24 hours a day, not shown in FIG. 8, may be provided in the system. This is because an operations method for correction in a case where the applicant writes in error should be supported, when the receiving personal computer 110 is provided at a convenience store, for example.

The hardware structure in the computer system of the local government terminal 10, the receiving personal computer 110, and the DB server 9 shown in FIG. 8 is substantially the same as the first embodiment of the present invention described above with reference to FIG. 2.

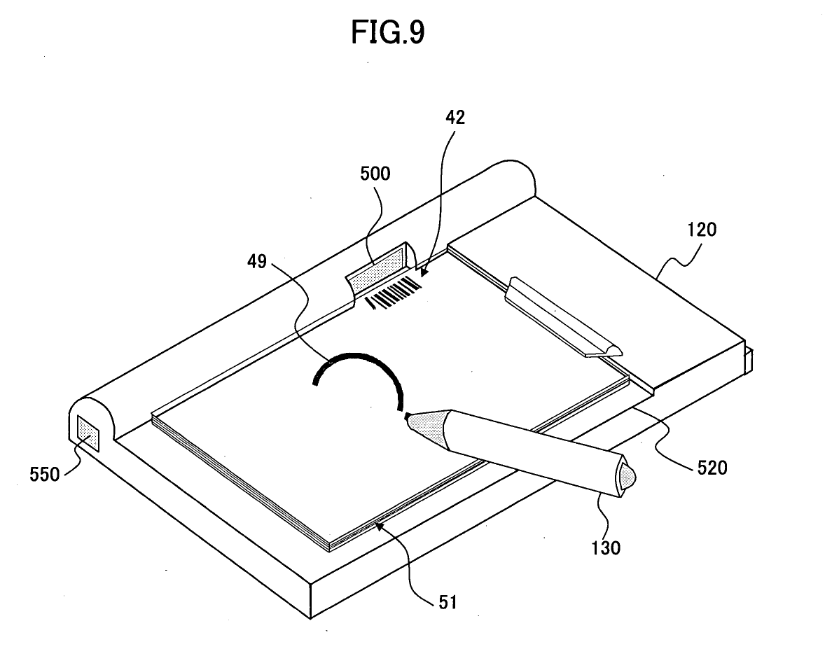

Next, the handwriting input device 120 will be discussed with reference to FIG. 9. The handwriting input device 120 includes a handwriting information acquiring tablet 520, a mark image reading part 500, and a data forwarding part 550.

As for the handwriting information acquiring tablet 520, it is possible to use a similar device such as a well known tablet. However, it is preferable that it be possible to actually write on paper by using the tablet. In this case, an electromagnetic induction type tablet or a supersonic type tablet is used as the handwriting information acquiring tablet 520. In this case, the excusive pen 130 also corresponds to these tablets.

The mark image reading part 500 reads and analyzes the mark image 42 which corresponds to identifier information printed on the application document 51 so that the identifier information is acquired.

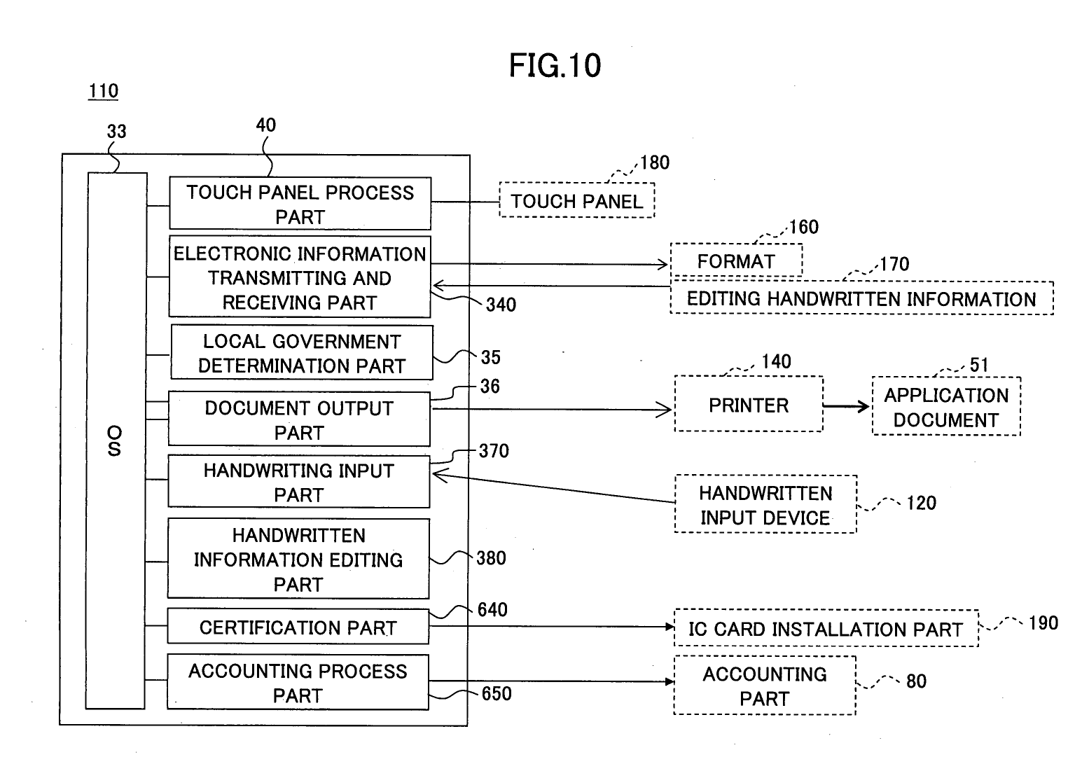

The data forwarding part 550 is, for example, a serial connection device, a USB connection device, or an Ethernet (Trademark) connection device. The data forwarding part 550 forward the handwritten information 49 that is read out and the identifier information to a handwritten information editing part 380 (See FIG. 10).

The handwriting input device 120 may include a storage device, so that acquired data are stored first and then forwarded to the receiving personal computer 110 after the writing process is completed. Furthermore, the handwriting input device 120 may be operated independently by battery power.

Next, the receiving personal computer 110 is described with reference to FIG. 10 showing a software block diagram. The receiving personal computer 110 includes an OS 33, an electronic information transmitting and receiving part 340 operated by the OS 33, the local government determination part 35, an application document output part 36, a handwriting input part 370, a handwritten information editing part 380, a touch panel process part 40, a certification part 640, and an accounting process part 650.

The electronic information transmitting and receiving part 340 which functions as a format acquiring part and a handwritten information transmitting and receiving part, receives a format 160 of the application document from the DB server 9 and sends the edited handwritten information 170 to the local government terminal 10. The local government determination part 35 determines a local government ID for the local government selected by the applicant. The application document output part 36 is a driver of the printer 140 so as to print and output the format received from the DB server 9 as the application document 51. The application document output part 36 and the printer 140 function as a printing part.

The touch panel process part 40 is a driver of the touch panel 180. The certification part 80 reads the applicant information from the IC card installed in the IC card installation part 190.

The handwriting input part 370 is a driver of the handwriting input device 120. The handwritten information that is handwritten on the application document 51 by the excusive pen 130 is electronically acquired from the handwriting input device 120. The fee amount is determined by the accounting process part 650. The accounting process part 650 also controls the accounting part 80 wherein money is actually deposited.

The handwritten information editing part 380 edits the handwritten information acquired from the handwriting input part 370. The handwriting input part 370, the handwriting input device 120, and the excusive pen 130 form a handwritten information acquiring part.

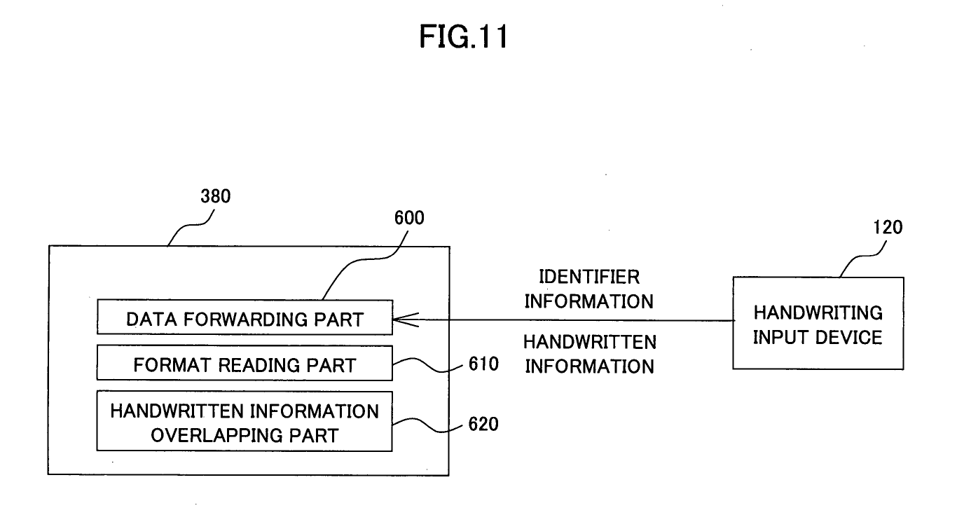

Next, details of the handwritten information editing part 380 are described with reference to FIG. 11. The handwritten information editing part 380 includes a data forwarding part 600, a format reading part 610, and a handwritten information overlaying part 620.

The data forwarding part exchanges information such as acquired handwritten information with the handwriting input device 120.

The format reading part 610 reads an electronic transcript, that is identified based on the identifier information, from a format that is received from the DB server 9 (See FIG. 8) by the electronic information transmitting and receiving part 340 (See FIG. 10) and that is stored first in the auxiliary storage 26 (See FIG. 2).

The handwritten information overlapping part 620 overlays the handwritten information acquired by the data forwarding part 600 on the application document read out by the format reading part 610, so that the edited handwritten information 170 (See FIG. 10) is formed.

The application document printed by the printer 140 is substantially the same as the first embodiment explained with reference to FIG. 4.

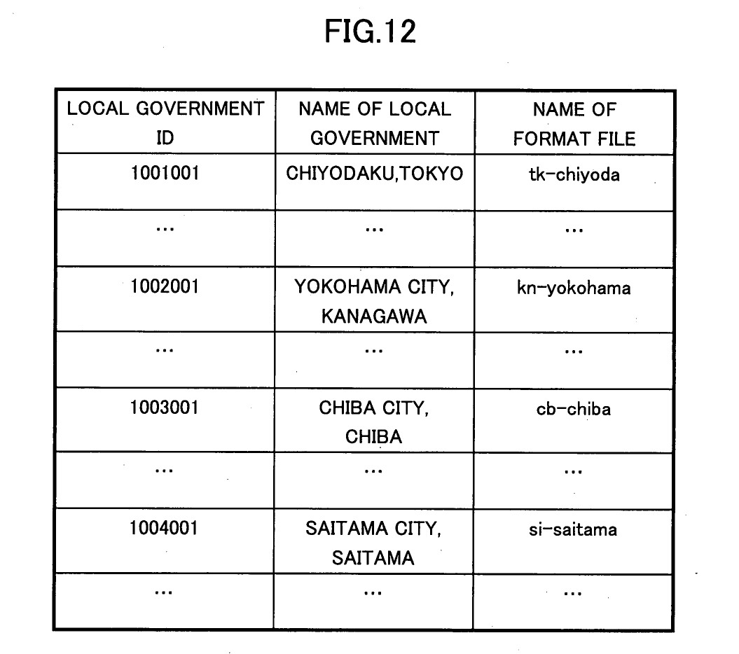

Next, with reference to FIG. 12, a local government data base (hereinafter “DB”) wherein all of a country's standard application formats are stored, which is installed in the DB server 9, is explained with reference to FIG. 12. For convenience of explanation, the local government DB shown in FIG. 12 corresponds to only the resident's card.

The local government DB shown in FIG. 12 is formed by three items, namely a local government ID, a name of the local government, and a name of a format file.

The local government ID is a number given to each local government separately. The name of the local government is the name of a local government corresponding to the local government ID. The name of the format file is the name of a file where the format for every local government is stored.

For example, in a case where the local government ID is 1001001, the local government is Chiyodaku, Tokyo and the name of file where the format is stored is tk-chiyoda. Because of this local government DB, if the local government ID is designated by the receiving personal computer 110, the DB server 9 searches the local government DB with the local government ID as a key, so that the name of the format file is acquired and the DB server 9 transmits the format stored at the format file to the receiving personal computer 110.

The receiving personal computer 110 also has data formed by the local government ID and the name of the local government among items of the local government DB shown in FIG. 7. The receiving personal computer 110 searches for the local government ID using names of prefectures and cities selected by the applicant as keys, so as to transmit the selected local government ID to the DB server 9.

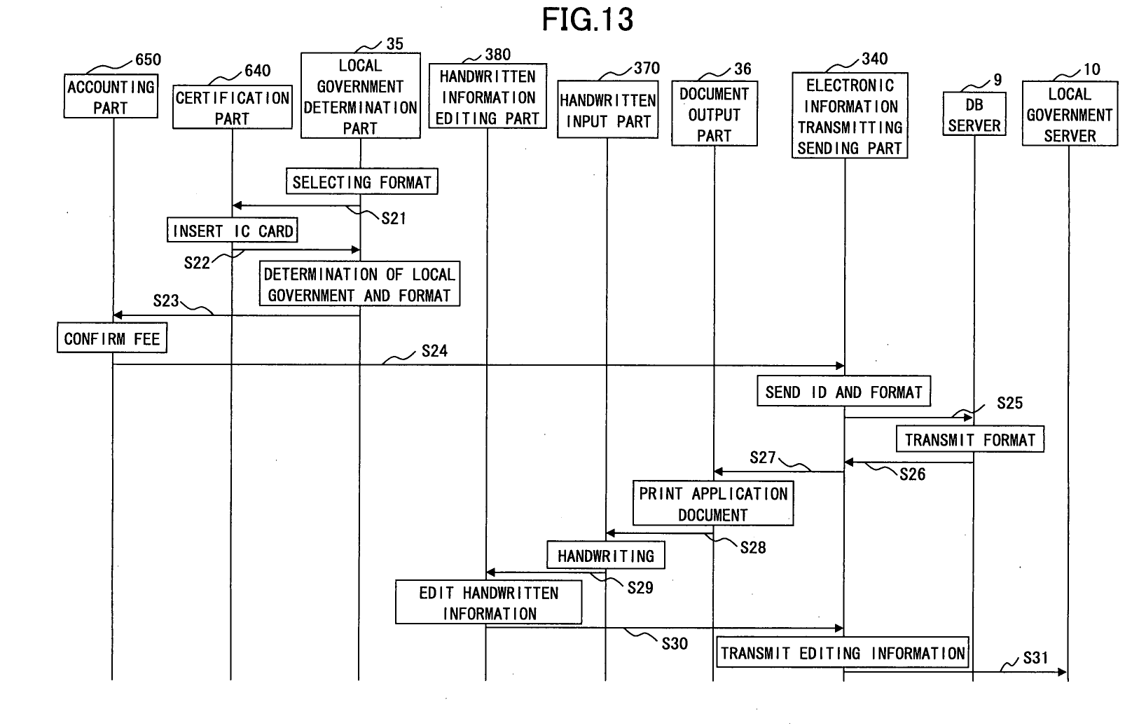

Next, a process wherein the receiving personal computer 110 prints the resident's card is explained with reference to a sequence diagram shown in FIG. 13. In FIG. 13, a process is shown by which respective software blocks provided at the receiving personal computer 110, the DB server 9, and the local government server 10 perform work.

First, the applicant selects the application document format by using the touch panel 180, and the local government determination part 35 gives notice for performing a certification process to the certification part 640 (Step 21).

Next, the certification part 640 reads address, name, gender, date of birth, age, and others from the IC card inserted into the IC card installation part 19 by the applicant. The certification part 640 gives notice of the local government that is read to the local government determination part 35 (Step 22). Because of this, it is possible for the local government determination part 35 to determine the local government and the application document format.

The local government determination part 35 gives notice of the fee for performing to the accounting process part 650 (Step 23).

After confirming payment of the printing fee, the accounting process part 650 gives notice for transmitting the local government ID and the application document format to the electronic information sending and transmitting part 340 (Step 24). The electronic information sending and transmitting part 34 transmits the local government ID and the application document format to the DB server 9 (Step 25).

The DB server 9 transmits the application document format (Step 26).

The application document format is transmitted from the electronic information sending and transmitting part 340 to the document output part 36 (Step 27). The document output part 36 performs a printing step. That is, the document output part 36 prints information of the applicant read by the certification part 640 to a corresponding section of the application document so that the application document is printed based on the format. At this time, the identifier information is also printed.

Next, the document output part 36 gives the handwritten input part 370 a notice indicating printing is completed (Step 28).

The handwritten input part 370 performs a handwritten information acquiring step. That is, the handwritten input part 370 performs a process for acquiring handwritten information that is handwritten by the applicant, on the application document that is input on paper, and transmits the handwritten information to the handwritten information editing part 380 (Step 29). The handwritten information editing part 380 edits the handwritten information.

After editing the handwritten information, the handwritten information editing part 380 gives notice for performing a notifying step to the electronic information transmitting and receiving part 340 (Step 30). The electronic information transmitting and receiving part 340 transmits the handwritten information to the local government terminal (Step 31).

In the system and method for processing a handwritten document of the second embodiment, people who cannot obtain the advantage of improved service for residents, despite the construction of an electronic local government, because they are not good at operating a personal computer, can electronically apply with a conventional paper handwritten application document.

Furthermore, a staff member of a public office does not have to work on both paper applications and electronic applications. In addition, people who follow do not have to wait for a long time for a person to make an application at a place where a receiving personal computer is arranged, such as a convenience store.

The above discussed system for processing documents can be applied to other window services such as applications for banks, travel, cellular phones, or the like.

According to the second embodiment of the present invention, it is possible to provide a system and method for processing a handwritten document, and thereby a handwritten document is made electronic.

The present invention is not limited to these embodiments, but variations and modifications may be made without departing from the scope of the present invention.

This patent application is based on Japanese Priority Patent Applications No. 2003-72627 filed on Mar. 17, 2003 and No. 2003-72628 filed on Mar. 17, 2003, the entire contents of which are hereby incorporated by reference.

What is claimed is:

1. A system for processing a handwritten document, comprising:
a receiving terminal configured to acquire handwritten information that is handwritten on a document;
a document receiving terminal configured to receive the handwritten information that is transmitted from the receiving terminal; and
a format storage terminal configured to store a format of the document,
wherein the receiving terminal includes:
a format acquisition part which acquires the format of the document from the format storage terminal;
a printing part which prints the document based on the format acquired by the format acquisition part;
a handwritten information acquiring part which acquires the handwritten information that is handwritten on the document; and
a handwritten information transmitting part which transmits the handwritten information to the document receiving terminal.

2. The system for processing a handwritten document as claimed in claim 1,
wherein the printing part prints identifier information, by which the handwritten information acquiring part identifies the document, with the document.

3. The system for processing a handwritten document as claimed in claim 1, further comprising:
a certifying terminal configured to certify a user who handwrites the handwritten information on the document,
wherein the receiving terminal further includes:
a certifying part which transmits and received necessary information for the certification to and from the certifying terminal;
an accounting process part which collects a service fee required based on printing of a publication document which is published based on an application made by the document; and
a publication document information acquiring part which acquires information regarding the publication document from the document receiving terminal.

4. The system for processing a handwritten document as claimed in claim 3,
wherein the printing part prints identifier information, by which the handwritten information acquiring part identifies the document, with the document.

5. The system for processing a handwritten document as claimed in claim 3,
wherein the format of the document is determined by the information regarding the certification acquired by the certifying part.

6. The system for processing a handwritten document as claimed in claim 3,
wherein the handwritten information that is edited is transmitted to the document receiving terminal with the information of the document in a case where the certification is confirmed by the certifying part, and
information about the publication document is transmitted from the document receiving terminal to the publication document information acquiring part.

7. A method for processing a handwritten document in a system for processing document, the system including a receiving terminal configured to acquire handwritten information that is handwritten on a document; a document receiving terminal configured to receive the handwritten information that is transmitted from the receiving terminal; and a format storage terminal configured to store a format of the document, the method comprising the steps of:
a) acquiring the format of the document from the format storage terminal;
b) printing the document based on the format acquired;
c) acquiring the handwritten information that is handwritten on the document; and
d) transmitting the handwritten information to the document receiving terminal.

8. The method for processing a handwritten document as claimed in claim 7,
wherein, in the step b), identifier information for identifying the document in the step c), is printed with the document.

9. The method for processing a handwritten document as claimed in claim 7,
wherein the system further includes a certifying terminal configured to certify a user who handwrites the handwritten information on the document, and
further comprising the steps of:
e) transmitting and receiving necessary information for the certification to and from the certifying terminal,
f) collecting a service fee required based on printing of a publication document which is published based on an application made by the document; and
g) acquiring information regarding the publication document from the document receiving terminal.

10. The method for processing a handwritten document as claimed in claim 9,
wherein, in the step b), identifier information for identifying the document in the step c), is printed with the document.

11. The method for processing a handwritten document as claimed in claim 9,
wherein the format of the document is determined by the information regarding the certification.

12. The method for processing a handwritten document as claimed in claim 9,
wherein the handwritten information that is edited is transmitted to the document receiving terminal with the information of the document in a case where the certification is confirmed.
